(19) United States
(12) Patent Application Publication
(10) Pub. No.: US 2014/0079938 A1
(43) Pub. Date: Mar. 20, 2014

(54) PLASTIC FILM

(71) Applicants: Matthias PERICK, Ahaus-Alstaette (DE); Herbert Bader, Nordwalde (DE); Joachim Hawighorst, Georgsmarienhuette (DE)

(72) Inventors: Matthias PERICK, Ahaus-Alstaette (DE); Herbert Bader, Nordwalde (DE); Joachim Hawighorst, Georgsmarienhuette (DE)

(21) Appl. No.: 14/027,295

(22) Filed: Sep. 16, 2013

(30) Foreign Application Priority Data
Sep. 17, 2012 (DE) 102012108705.9

(51) Int. Cl. B32B 27/32; B32B 5/18

(52) U.S. Cl. CPC B32B 27/32; B32B 5/18
USPC 428/220

(57) ABSTRACT

A plastic film having a thickness of less than 400 μm has a base layer at least partially of polyolefin of renewable raw material or a polyolefin mixture of renewable raw material and a first layer foamed by at least 20%.

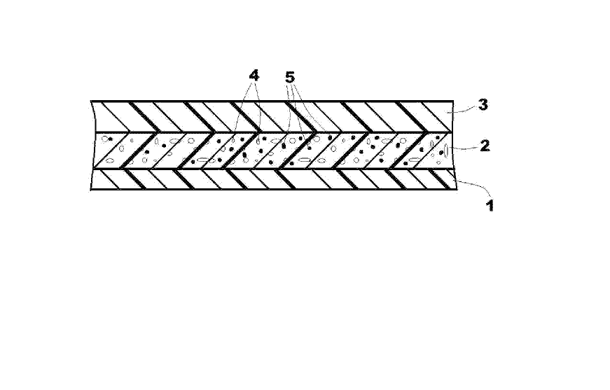

### FIELD OF THE INVENTION

The present invention relates to a plastic film. More particularly this invention concerns a plastic film containing a polyolefin made from renewable raw materials or a polyolefin mixture with a polymer made from renewable raw materials.

### BACKGROUND OF THE INVENTION

Polymers are usually made from fossil hydrocarbons, in particular petroleum. Accordingly, carbon compounds are used and released that have a negative effect on the balance of CO₂, damaging the climate. Petroleum is also a finite raw material, so that at least in the medium term alternative raw materials must be identified and used. In this connection dependence of the plastic processing industry upon petroleum production and upon the petroleum price that is subject to considerable fluctuations is negative.

Against this background it is known to use plastics from renewable raw materials in the production of molded parts and films from plastic. An improvement in the CO₂ balance can be achieved when some of the fossil hydrocarbon compounds in a polymer compound are replaced by renewable raw materials.

When polymers are used that are formed using renewable raw materials there are various approaches. Thus for example polymers already occurring in biomass, such as cellulose and starch, can be used with no or only slight modification. In particular thermoplastic starch (TPS) can be blended with a conventional polyolefin. Furthermore polymers such as polylactic acid (PLA) are known that are made by suitable organic compounds such as for example glucose.

Finally, a bioalcohol made from renewable raw materials is then used for making conventional polyolefins. A method of making polyolefins from renewable raw materials is known from WO 2008/067627 (U.S. 2010/0069691). This method is derived from prior art according to which ethylene is obtained as starting product for polymerization by dehydration of bioalcohol.

A plastic film is known from WO 2011/140496 (U.S. 2011/0274892) where a biaxially oriented plastic film contains a polyolefin made from renewable raw materials. According to WO 2011/140496 a mixture of fossil raw materials and renewable raw materials can be used. As a measurement of the proportion of renewable raw materials a determination by the C14 isotope test according to ASTM D 6866 is provided that can also be used in the context of the present invention for the purpose of verification.

### OBJECTS OF THE INVENTION

It is therefore an object of the present invention to provide an improved polymer.

Another object is the provision of such an improved polymer that overcomes the above-given disadvantages, in particular that is based on renewable raw materials and achieves an additional improvement of the CO₂-balance.

### SUMMARY OF THE INVENTION

A plastic film having a thickness of less than 400 μm has according to the invention a base layer at least partially of polyolefin of renewable raw material or a polyolefin mixture of renewable raw material and a first layer foamed by at least 20%.

This 20% increase in volume relates to a comparison with an unfoamed film layer formed from the same quantity of polymer. Due to the foaming of the at least first foamed film layer, with the same material input a greater volume and a higher stability is achieved. If on the other hand, as usual, the material properties such as strength and film thickness are predetermined, the material input can be reduced appropriately by foaming. The plastic film is preferably a blown film, that is to say a film that is made by blown film extrusion or blown film coextrusion. The thickness of the plastic film usually amounts to less than 400 μm.

In principle the plastic film may be constructed as a monofilm. The foamed film layer is then the only layer of the plastic film and contains the polyolefin from renewable raw materials or a polyolefin mixture with a polymer formed from renewable raw materials.

According to a preferred embodiment of the invention the plastic film according to the invention is a multilayer coextruded film that in particular can also be made in the above-described blown film process.

In a multilayer design it is possible to adapt the layer structure optimally to the particular requirements. In particular foamed and unfoamed film layers can also be combined with one another. In particular in an at least three-layered structure the foamed film layer can be a core layer between the first unfoamed layer and the also normally unfoamed base layer. Within the context of such an embodiment a particularly great match to an unfoamed film is obtained, but the foamed core layer results in a saving of material. Furthermore use of the second unfoamed layers result in a certain plywood effect, according to which the outer unfoamed layers stabilize the entire film. In this case it should be taken into consideration that on bending or kinking of the film the outer layers essentially determine the stability, while the core layer is located in the region of the neutral fibers.

Finally, depending upon the application an additional function can also be provided by the foaming of the at least one film layer. By comparison with an unfoamed film layer with the same overall thickness, this results in not only a lower density of typically less than 0.8 g/cm³, but also a certain softness. With pointed, sharp-edged objects the entire film is flexible to a certain extent if it contains at least one foamed film layer, so that the applied force can be distributed over a greater area.

Furthermore the foamed plastic film may also be provided in order to absorb liquids. If the plastic film is used for example as packaging for foodstuffs, liquid given off from the foodstuffs can be absorbed to a certain extent in the foamed layer. The can occur in particular when the plastic film is part of a microwave packaging and the foodstuff is heated in the microwave packaging. The absorption capacity of the foamed layer can also be further increased by the addition of a superabsorbent polymer to this layer. A superabsorbent polymer is usually a copolymer consisting of acrylic acid and sodium acrylate, whereby superabsorbent polymers can absorb up to 500 times their own weight of liquid.

According to the invention a plastic film is provided containing as essential constituent polyolefin that is formed of renewable raw materials or is mixed with renewable raw materials. Thus a polyethylene based on renewable raw materials is used that is obtained for example from sugar-cane cellulose or organic waste. Corresponding polymers are formed predominantly from renewable raw materials. At present these frequently also include a proportion of fossil carbon as plastics designated as biopolymers where the proportion of renewable raw material may typically be 80 to 90%.

A further material that is suitable to a particular extent is a mixture from thermoplastic starch (TPS) with polyethylene that is usually obtained from fossil raw materials. In this case the proportion of carbon from renewable raw materials is approximately ⅔ of the entire quantity of polymer. Furthermore a mixture of thermoplastic starch (TPS) with polypropylene (PP) can also be provided.

In order to optimize the proportion of renewable raw materials the thermoplastic starch (TPS) can also be mixed with a polyethylene of which at least a part is formed from renewable raw materials.

The plastic film according to the invention can usually have fillers that may be provided for volume enlargement or coloring. A dye can be provided in order to achieve an opaque, colored film. In order to produce a white printable film, a white batch is usually provided on the basis of titanium oxide (TiO₂), typically with a proportion of up to 20% in the individual film layers.

The at least one foamed film layer can optionally contain a filler consisting of organic particles can also optionally be provided in order during foaming to bring about a nucleation, i.e. formation of as many small cells as possible. In this case particularly suitable fillers are chalk or talc that can be provided for example with a proportion by weight of 5 to 30% in the foamed film layer. When such a filler is used as an aid to nucleation with the described TPS-PE mixture, surprisingly in practice a greater degree of foaming can be achieved than with pure PE. Therefore the thermoplastic polystarch is suitable to a particular extent for use in a foamed layer. The effective foaming in the case of a TPS-PE mixture nay be attributed to the fact that the thermoplastic starch itself constitutes an initiator for nucleation. Thus, depending upon the degree of foaming it may be possible to dispense completely with a further addition of fillers as an aid to nucleation.

The described coloring by a dyestuff is merely optional in plastic film according to the invention. However, due to the at least one foamed film layer there will always be a certain clouding, so that no completely clear, fully transparent plastic film is provided.

According to a preferred modification of the invention the at least one foamed film layer has a microcellular structure that is formed by the addition of an inert gas during an extrusion process. In principle various foaming reactions are known, in which different foam formers can be added to the thermoplastic polymer during processing thereof. However, a particularly uniform, small-cell bubble structure can be achieved by the adding of an inert gas, for example carbon dioxide or nitrogen, during the extrusion process. For this purpose the inert gas is delivered to the extruder and under the action of pressure within the extruder is mixed with the polymer to produce a homogeneous or almost homogeneous substance. Due to the pressure drop during extrusion a phase separation then takes place in which uniformly distributed small cells or bubbles form in the entire material. The formation of individual cells may be further improved by the previously described fillers in the form of chalk or talc. The supplied quantity of gas preferably amounts to between 0.02 and 0.25% by weight.

In the case of coextrusion, the foam-forming substance, that is to say in particular the inert gas, can be added to only a layer or a part of the layers.

The foaming method that is particularly suitable in the context of the invention is described in U.S. Pat. No. 6,051,174, WO 1998/008667 (U.S. Pat. No. 6,284,810), WO 2001/089794 (U.S. Pat. No. 6,593,384), WO 2002/014044 (U.S. Pat. No. 6,616,434) and WO 2004/039552 (U.S. Pat. No. 7,144,532). The method is also designated in practice as the MuCell foaming method, where devices for carrying out the method or for retrofitting conventional extruders are marketed by Trexel Inc., USA. The supplied quantity of gas preferably amounts to between 0.02 and 0.25% by weight.

As already explained, the plastic film according to the invention may also include a considerable proportion of polyolefin or another plastic derived from fossil raw materials. At the outset the usual, currently available biopolymers themselves contain a proportion of carbon from fossil raw materials. Furthermore the desired film properties are achieved in practice precisely by mixing various plastics. In particular, if because of the technical requirements it is not possible to dispense with a proportion of fossil raw materials, due to the foaming this results in a considerable additional use with regard to the CO₂ balance. The total proportion by weight of constituents that are formed from renewable raw materials preferably amounts to at least 25%, particularly preferably at least 30%.

According to the invention, due to the foaming the foamed film layer increases in volume by at least 20%. In other words the cells not filled with polymer take up a corresponding proportion of the volume. As already explained above, there is preferably a microcellular structure that may be formed for example by means of the MuCell foaming method. The cells are usually significantly smaller than the thickness of the foamed film layer, so that the embodiment of the individual, preferably closed cells constitutes a microstructuring. The increase in volume caused by the foaming can easily amount to 100% or more by comparison with an unfoamed layer. Due to the preferred foaming is during the extrusion process the cells may also have a considerable orientation, wherein the cells are elongated in the production direction, that is to say in the plane of the film.

In order to make a considerable contribution to the saving of CO₂ with regard to the raw materials, the proportion of the volume of the cells formed by foaming based on the entire plastic film amounts to preferably at least 20%, particularly preferably at least 30%.

The plastic film, or the layers of film provided in a multilayer construction can have the customary additives. If the at least one foamed film layer has a lubricant capable of migration, by comparison with an unfoamed film layer a higher quantity of lubricant must be used, since the entire surface of the foamed film is enlarged by the cells and the lubricant can also migrate to the surfaces formed within the layer in the cells.

The plastic film according to the invention based on polyolefin usually has at least one heat-sealable layer. If the plastic film is provided as a monofilm processed or the at least one first foamed layer forms an outer face of a multilayer coextruded film forms, the foamed film layer may also be provided as a sealing layer. In this case welding can be done by pressure and temperature, a laser or also by ultrasound. Contrary to expectations, within the context of the invention a highly foamed layer can also be sealed by ultrasound, although due to the open cells in principle a less effective energy input by ultrasound should be expected. Surprisingly, however, tests have shown that with regard to welding by ultrasound no significant impairments by comparison with an unfoamed film layer are observed.

The plastic film is suitable in particular as a packaging film for packaging in bags. In this case it is possible to make the entire bag packaging exclusively from the plastic film, where in a multilayer configuration the first layer is provided as a sealing layer and an opposite unfoamed second layer is provided as a printable layer.

Furthermore the plastic film according to the invention can also be laminated with a further film, so pouch packagings or lidding films for tray packagings can then be formed from the laminating film. In particular lamination onto a film or film layer made from polyethylene terephthalate (PET), biaxially oriented polypropylene (BO-PP) or also from a film formed from renewable raw materials. Such biobased films may for example be films made from cellulose, polylactic acid (PLA) or biobased PET (Bio-PET) that may also be easily subjected to orientation (OPLA/Bio-OPET).

The plastic film according to the invention can be made so that it is free from constituents that are harmful to health and toxic, so that this film is also suitable to a particular extent as a packaging for foodstuffs and animal feed. Furthermore the packaging can also be used for textiles, hygiene articles or the like.

### BRIEF DESCRIPTION OF THE DRAWING

The above and other objects, features, and advantages will become more readily apparent from the following description, reference being made to the accompanying drawing that is not to scale and whose sole figure is a section through a plastic film according to the invention.

### SPECIFIC DESCRIPTION OF THE INVENTION

As seen in the drawing a foam has a base layer 1, a first layer 2, and a second layer 3. Cells or air bubbles in the first layer are shown at 5 and hard inorganic particulates at 6. The dimensions, compositions, and other properties of the layers 1, 2, and 3 are as shown in Tables 1 and 2 below.

According to a first embodiment a three-layered plastic film with an overall thickness of 100 μm and with a symmetrical layer structure was made by blown film coextrusion. According to Table 1 the two outer layers 1 and 3 are formed with a thickness of 15 μm from mixtures of polyethylene, with up to 60% by weight of these layers consisting of a low-density linear polyethylene (Bio-PE-LLD) formed substantially from renewable raw materials. The proportion of renewable raw materials (RRM) therein amounts to more than 80%. In addition to a low-density polyethylene formed from fossil raw materials, a white batch is provided with a proportion of 10% by weight for coloring. The densities given in the table relate to the unit g/cm³. The melt flow index MFI is given in g/10 min.

Due to foaming, the core layer 2 has a volume enlargement of 100% and contains 30% of a low-density linear polyethylene formed from renewable raw materials. This Bio-PE-LLD is mixed with oil-based or also biobased low-density polyethylene types. In addition a talc batch with a proportion by weight of 20% is obtained that as an aid to nucleation supports the foaming.

The total proportion of renewable raw materials (RRM) based on the total film amounts to between 30% and 50%. Due to the foaming a reduction in the density by approximately 30-40% is achieved by comparison with a compact film of the same thickness. Thus by comparison with a compact film of the same thickness this results in an overall reduction of fossil carbon by 50-70%

TABLE 1

| Layer 1 unfoamed, | Layer 2 foamed, | Layer 3 unfoamed, |
|---|---|---|
| thickness 15 μm | thickness 70 μm | thickness 15 μm |
| 60% Bio-PE-LLD | 30% Bio-PE-LLD | 60% Bio-PE-LLD |
| (density = 0.915 to | (density = 0.915 to | (density = 0.915 to |
| 0.925, MFI = 2 to 3, | 0.925, MFI = 2 to 3, | 0.925, MFI = 2 to 3, |
| RRM >80%) | RRM >80%) | RRM >80%) |
| 30% PE-LD (density = | 30% PE-LLD-C8 | 30% PE-LD (density = |
| 0.92 to 0.93, | (density = 0.915 to | 0.92 to 0.93, MFI = 1.5 |
| MFI = 1.5 to 2.5) | 0.925, MFI = 3 to 8) | to 2.5) |
| 10% white batch | 20% PE-LD (density = | 10% white batch based |
| based on TiO₂ | 0.915 to 0.925, MFI = | on TiO₂ |
| | 3 to 8) | |
| | 20% talc batch | |
| | quantity of gas | |
| | injected (N2) = 0.01% | |
| | by weight | |

According to the second embodiment, a polyolefin mixture containing thermoplastic starch and polyethylene from fossil raw materials (TPE-PE-Compound) is also used in a two-layer film formed by blown film coextrusion. The thickness the film amounts to 120 μm. In this plastic the total proportion of renewable raw materials amounts to between 40% and 70%. In the three layers this polyolefin mixture with a renewable raw material is mixed with polyethylene and ethylene vinylacetate from fossil raw materials. In order to improve the nucleation, i.e. the formation of small cells, the foamed core layer 2 contains 10% by weight of a talc batch. Due to the foaming the core layer 2 has a volume enlargement by a factor 2.6 (from 30 μm to 80 μm), although a smaller quantity of chalk batch has been used by comparison with the first embodiment. The improved foaming is attributable to the fact that in the MuCell method s used the thermoplastic starch within the TPS-PE compound additionally supports the nucleation, wherein a comparatively high degree of foaming is achieved.

TABLE 2

| Layer 1 unfoamed, | Layer 2 foamed, | Layer 3 unfoamed, |
|---|---|---|
| thickness 20 μm | thickness 80 μm | thickness 20 μm |
| 45% TPS-PE | 45% TPS-PE | 45% TPS-PE |
| compound | compound | compound |
| (density = 1.1 to | (density = 1.1 to | (density = 1.1 to |
| 1.3, MFI = 1 to 4, | 1.3, MFI = 1 to 4, | 1.3, MFI = 1 to 4, |
| RRM = 40 to 70%) | RRM = 40 to 70%) | RRM = 40 to 70%) |
| 32% PE-LLD-C4 or | 37% PE-LLDm-C4 or | 32% PE-LLD-C4 or |
| -C6 (density = 0.91 to | -C6 (density = 0.91 | -C6 (density = 0.91 to |
| 0.93, MFI = 2 to 3) | to 0.92, MFI = 10 to | 0.93, MFI = 2 to 3) |
| 15% PE-LD (density = | 18) | 15% PE-LD (density = |
| 0.92 to 0.93, MFI = 1 | 10% talc batch | 0.92 to 0.93, MFI = |
| to 3) | 8% EVA (VA proportion | 1 to 3) |
| 8% EVA (VA | 15 to 30%, density = | 8% EVA (VA |
| proportion 15 to 30%, | 0.93 to 0.95, MFI = 1 | proportion 15 to |
| density = 0.93 to 0.95, | to 5) | 30%, density = 0.93 |
| MFI = 1 to 5) | quantity of gas | to 0.95, MFI = 1 to |
| | injected (N2) = 0.1% | 5) |
| | by weight | |

We claim:

1. A plastic film having a thickness of less than 400 μm and comprising:
a base layer at least partially of polyolefin of renewable raw material or a polyolefin mixture of a renewable raw polymer material; and
a first layer foamed by at least 20%.

2. The plastic film defined in claim 1, wherein the film is blown.

3. The plastic film defined in claim 1, wherein the layers of the film are coextruded.

4. The plastic film defined in claim 1, wherein both the base and first foamed layer are of polyolefin of renewable raw material or a polyolefin mixture of renewable raw material.

5. The plastic film defined in claim 1, further comprising:
a second unfoamed layer.

6. The plastic film defined in claim 4, wherein the first foamed layer is between the second unfoamed layer and the base layer.

7. The plastic film defined in claim 1, wherein the first foamed layer has a microcellular structure formed by injection of an inert gas during an extrusion process.

8. The plastic film defined in claim 1, wherein another portion of the polyolefin of the base layer is from fossil raw material.

9. The plastic film defined in claim 1, wherein the proportion of renewable raw material is at least 25%.

10. The plastic film defined in claim 1, wherein the at least 20% of the film is formed of cellular foam.

11. The plastic film defined in claim 1, wherein the first foamed layer contains inorganic particles.

12. The plastic film defined in claim 1, wherein the first foamed layer contains a superabsorbing polymer.

13. The plastic film defined in claim 1, wherein the film is used as a packaging foil for making bags.
